(19) United States
(12) Patent Application Publication
(10) Pub. No.: US 2009/0129278 A1
(43) Pub. Date: May 21, 2009

(54) Method and apparatus for network based content enhancement

(76) Inventors: Gandarvakottai V. Kumar, Hyderabad (IN); S. Mohan Kumar, (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/013,000

(22) Filed: Feb. 6, 2008

Related U.S. Application Data
(60) Provisional application No. 60/888,455, filed on Feb. 6, 2007.
(60) Provisional application No. 60/889,485, filed on Feb. 12, 2007.

(51) Int. Cl. G06F 11/00

(52) U.S. Cl. 370/241

(57) ABSTRACT

A system and method of enhancing content of at least one message sent by a source device to at least one destination device over at least one network. The system is operative to receive a message over a network, in which the message has content associated therewith. The system analyzes the content of the received message, and selects additional information based upon the content of the received message. The system inserts the selected information into the message, and then transmits, over the network, the message and the selected information to a destination device. The selected information can include at least one advertisement.

### CROSS REFERENCE TO RELATED APPLICATIONS

This application claims benefit of U.S. Provisional Patent Application No. 60/888,455 filed Feb. 6, 2007 entitled METHOD AND SYSTEM FOR NETWORK BASED CONTENT ENHANCEMENT, and U.S. Provisional Patent Application No. 60/889,485 filed Feb. 12, 2007 entitled METHOD AND APPARATUS FOR NETWORK BASED CONTENT ENHANCEMENT.

### STATEMENT REGARDING FEDERALLY SPONSORED RESEARCH OR DEVELOPMENT

Not applicable

### BACKGROUND OF THE INVENTION

The present invention relates generally to the delivery of content over a communications network, and more specifically to a content enhancement platform operative to receive one or more messages sent over a communications network, to analyze the content of the message, to access additional information based upon the analyzed content, and to optionally insert the accessed information into the message for subsequent forwarding over the network.

Recent advances in communications devices and networks have led to a significant increase in peer-to-peer communications, which typically involve the delivery of content and/or information between a source peer device and a destination peer device over a network. In peer-to-peer communications, the source peer device is generally the initiator of a message containing the content and/or information to be communicated over the network, while the destination peer device is generally the intended recipient of the message. As the initiator of the message, the source peer device determines what device is to take on the role of the destination peer device, when to communicate with the destination peer device, what content and/or information is to be included in the message, and how the message is to be delivered over the network. Accordingly, the source peer device is generally aware of the overall context in which the content and/or information is to be sent to the destination peer device.

Subscribers to peer-to-peer communications services are looking for services and tools that enhance their chosen communication content, and make the communication more complete based upon the context of the message being delivered. Additionally, service providers are looking for methods that would help them subsidize, incentivize, or provide additional benefits for using and promoting peer-to-peer communications. Furthermore, information, advertisement, and content service providers are looking for opportunities to use the subscribers' peer-to-peer communications to enable enhanced content and/or information delivery.

### BRIEF SUMMARY OF THE INVENTION

In accordance with the present invention, a system and method of enhancing content of at least one message sent by a source device to at least one destination device over at least one network is provided. In the presently disclosed embodiment, the system is operative to receive a message over a network, in which the message has content associated therewith. The system analyzes the content of the received message, and selects additional information based upon the content of the received message. The system inserts the selected information into the message, and then transmits, over the network, the message and the selected information to a destination device.

In one embodiment, the destination device has a user associated therewith, and the system accesses demographic information associated with the user. The system then selects the additional information based upon the content of the received message and the demographic information associated with the user of the destination device. In addition, the system analyzes the content of the message to determine a context of the message by identifying one or more keywords included in the content of the received message. In one embodiment, the received message corresponds to a voice call message, and the system identifies one or more keywords using a speech recognition technique. In another embodiment, the received message corresponds to a text message, and the system identifies one or more keywords using a text searching technique. The identified keywords can correspond to at least one predetermined action and/or at least one predetermined location. The system can also analyze the received message to determine a time of receipt of the message, to identify a specified event, and to determine a time associated with the specified event. In one embodiment, the selected information corresponds to at least one advertisement.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 illustrates a source peer device and a destination peer device;

FIG. 2 illustrates a first embodiment of a network configuration including a source peer device, a destination peer device, and a content enhancement platform, according to the present invention;

FIG. 3 illustrates an exemplary embodiment of an architecture of the content enhancement platform of FIG. 2;

FIG. 4 illustrates exemplary declarations for a number of representative destination peers;

FIG. 5A illustrates an exemplary format of a representative message packet;

FIG. 5B illustrates a number of exemplary service type codes;

FIG. 6A illustrates a number of exemplary action keywords;

FIG. 6B illustrates a number of exemplary location keywords;

FIG. 7A illustrates a first embodiment of a specific advertisement database for a number of exemplary identified keywords;

FIG. 7B illustrates a first embodiment of a general advertisement database for a number of exemplary identified keywords;

FIG. 8A illustrates a second embodiment of a specific advertisement database for a number of exemplary identified keywords;

FIG. 8B illustrates a second embodiment of a general advertisement database for a number of exemplary identified keywords;

FIG. 9A illustrates a format of a first representative message packet for text messaging;

FIG. 9B illustrates a format of a first representative enhanced message packet for text messaging;

FIG. 10A illustrates a second representative message packet for text messaging having the format of FIG. 9A;

FIG. 10B illustrates a second representative enhanced message packet for text messaging having the format of FIG. 9B;

FIG. 11 illustrates an exemplary advertisement rate plan;

FIG. 12 illustrates an exemplary format of an advertiser account;

FIGS. 13A and 13B are flow diagrams illustrating an exemplary method for enhancing content using the network configuration of FIG. 2; and

FIG. 14 illustrates a second embodiment of a network configuration including a source peer device, a destination peer device, and a content enhancement platform, according to the present invention.

### DETAILED DESCRIPTION OF THE INVENTION

The disclosures of U.S. Provisional Patent Application No. 60/888,455 filed Feb. 6, 2007 entitled METHOD AND SYSTEM FOR NETWORK BASED CONTENT ENHANCEMENT, and U.S. Provisional Patent Application No. 60/889,485 filed Feb. 12, 2007 entitled METHOD AND APPARATUS FOR NETWORK BASED CONTENT ENHANCEMENT, are incorporated herein by reference in their entirety.

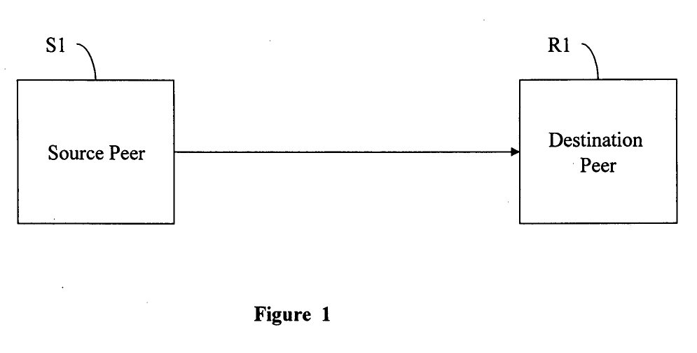

Content enhancement services typically involve adding additional information to peer-to-peer communications based upon the content of an original communication. In peer-to-peer communications, a source peer device (the “source peer”) generally communicates with a destination peer device (the “destination peer”) over a communications network. The source peer is the party that initiates the communication, while the destination peer is the recipient of the communication. FIG. 1 illustrates a typical source peer S1 communicating with a typical destination peer R1.

The source peer S1 can use any suitable communications method to communicate with the destination peer R1, including, but not limited to, voice calls, short message services (SMS; e.g., text messaging), multimedia message services (MMS), video sharing, video conferencing, instant messaging (IM), and e-mail communications. The communications methods can be implemented over any suitable type of network running any suitable network protocol such as the time division multiplexing (TDM) protocol, signaling system 7 (SS7) protocol, Internet protocol (IP), or the session initiation protocol (SIP).

According to one embodiment of the present invention, a content enhancement platform performs content enhancement services on peer-to-peer communications. For example, users of source peer devices may subscribe for the content enhancement services. When such a subscriber employs a source peer device to send a message to a destination peer device, the content enhancement platform receives the message before the message is forwarded to the destination peer. The content enhancement platform analyzes the content of the message, selects additional information based upon the content of the message, inserts the additional information into the message, and forwards the message, modified to include the additional information, to the destination peer. In another embodiment, the content enhancement platform can select the additional information based upon both the content of the message and demographic information associated with the destination peer, such as the age and gender of the user of the destination peer.

For example, a user of a source peer device who has subscribed for the content enhancement services may send the text message, “Meet me at Starbucks at Times Square in an hour”, to a destination peer. The message is forwarded to the content enhancement platform before the destination peer receives the message. The content enhancement platform identifies the source peer as a subscriber of the content enhancement services, and analyzes the content of the message. Based upon the content of the message, the content enhancement platform selects the advertisement, “Call 555-7900 for a QuickTaxi™ cab ride”, as the additional information. The content enhancement platform inserts the additional information into the original message, and forwards the modified message to the destination peer. As a result, the destination peer may receive the message, “Meet me at Starbucks at Times Square in an hour. Call 555-7900 for a QuickTaxi™ cab ride”.

As another example of the content enhancement services, content enhancement may be performed for video conferencing.

For example, a source peer may be engaged in a video conference with a destination peer regarding a proposed trip to Los Angeles. The content enhancement platform analyzes the content of messages sent from the source peer to the destination, and determines that the context of the communication relates to a trip to Los Angeles. The content enhancement platform selects additional information such discount information for Los Angeles hotels, and formats the data communicated between the source peer and destination peer so that the additional information appears as a banner at the bottom of the video screen.

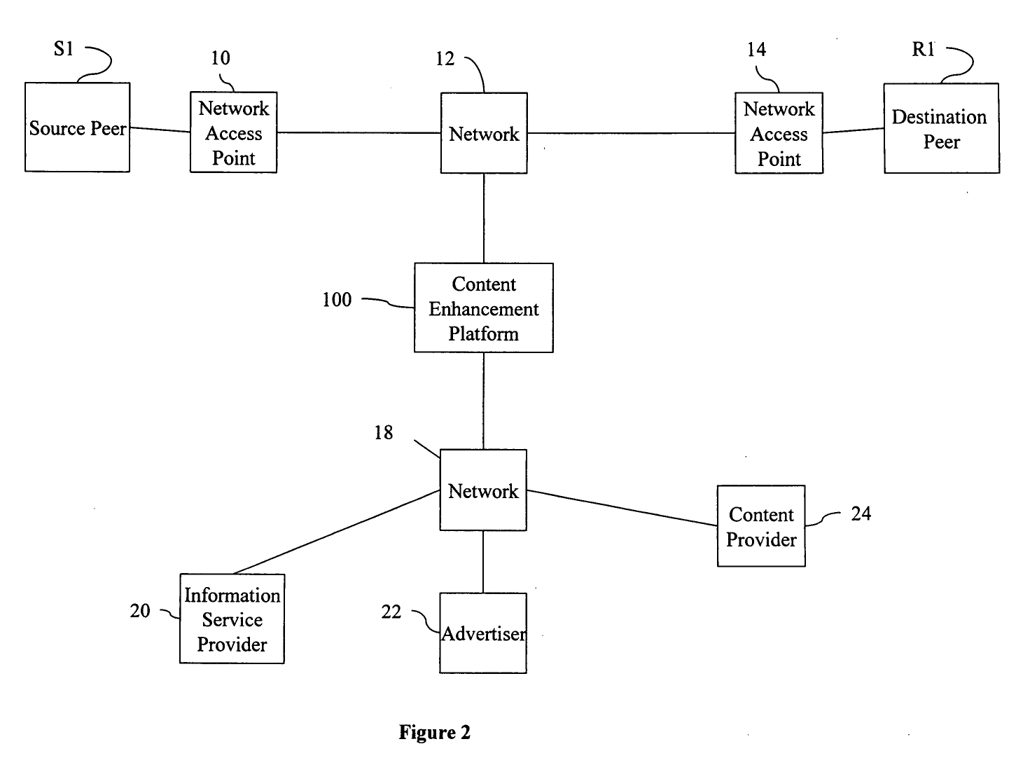

FIG. 2 depicts an illustrative embodiment of a network configuration including a source peer S1, a destination peer R1, a network 12, and a content enhancement platform 100. The source peer S1 is configured to communicate with the destination peer R1. Further, the source peer S1 and the destination peer R1 access the network 12 through network access points 10 and 14, respectively. The network access points 10 and 14 correspond to any suitable communications interfaces for providing access to the network 12 for any suitable type of communications device such as a computer, a cell phone, or a personal digital assistant (PDA). In addition, the network 12 can correspond to any suitable type of communications or computer network employing any suitable network protocol, including, but not limited to, the Internet running the Internet protocol (IP), a local area network (LAN) running the signaling system 7 (SS7) or session initiation protocol (SIP) for handling voice calls, or a wireless network employing the time division multiplexing (TDM) protocol.

Although the network configuration of FIG. 2 includes a single source peer S1 and a single network 12, it should be understood that the network configuration may alternatively include a plurality of source peers employing the same type or different types of networks. In addition, one or more network providers and/or one or more network protocols may be employed by the source peers to send messages. For example, the source peer S1 may correspond to a communications terminal (e.g., a PC) located in a house and connected to the Internet wirelessly and/or by wire or fiber optic cable using DSL or ADSL or a cable modem. Further, the destination peer R1 may correspond to a communications terminal operative to receive transmitted messages wirelessly, for example, via a mobile telephone service provider, or by wire or fiber optic cable. It is noted that any other suitable type of source or destination terminal, and any other suitable type of communications medium, may be employed.

Moreover, while FIG. 2 depicts the source peer S1 and the destination peer R1 communicating over the network 12, it should be understood that a desired communication between devices may pass through or use one or more servers. In addition, the desired communication between devices may not be a peer-to-peer communication, so long as the destination device is operative to receive content that is enhanced according to the methods described herein. The roles of the source and destination devices may also be reversed, if desired, after a message is sent and received.

According to one embodiment of the present invention, a message that is sent by the source peer S1 to the destination peer R1 is routed through the network access point 10 and the network 12 to the content enhancement platform 100 before the destination peer R1 receives the message. If the content enhancement platform 100 recognizes the source peer S1 as a subscriber of the content enhancement services, then the content enhancement platform 100 opens up the message. The content enhancement platform 100 then analyzes the content of the message to determine what information would be appropriate to add to the message before forwarding it to the destination peer R1.

In one mode of operation, the content enhancement platform 100 references one or more databases to select the additional information for insertion into the source peer's message. For example, the content enhancement platform 100 may include at least one memory that contains the database, or the database may be external to the content enhancement platform 100. Further, the content enhancement platform 100 may populate the database using information provided by information service providers 20, advertisers 22, and/or content providers 24. The content enhancement platform 100 can communicate with the information service providers 20, the advertisers 22, and the content providers 24 through a network 18, which may correspond to any suitable type of network running any suitable type of network protocol such as IP. It is understood that the information service providers 20, the advertisers 22, and the content providers 24 communicate with the content enhancement platform 100 using any suitable computer system communicably connectable to the network 18.

In the presently disclosed embodiment, the information providers 20, the advertisers 22, and the content providers 24 provide the content enhancement platform 100 with the additional information used for modifying a received message. For example, if the content enhancement platform 100 selects an advertisement as the additional information, then the advertiser 22 provides the selected advertisement to the content enhancement platform 100. In one embodiment, the advertiser 22 periodically sends advertisements to the content enhancement platform 100, which stores the advertisements in an advertisement database. When the content enhancement platform 100 selects an advertisement as additional information, the content enhancement platform refers to the advertisements in the advertisement database. In another embodiment, when the content enhancement platform 100 selects an advertisement as the additional information, the content enhancement platform 100 communicates with the advertiser 22 through the network 18 to receive an advertisement in real-time.

The content enhancement platform 100 is not limited to using advertisements as additional information for insertion into a received message. For example, in one embodiment, the content enhancement platform 100 communicates with the information provider 20 to receive directories indicating addresses and/or phone numbers of various locations, which the content enhancement platform 100 uses as the additional information. In another embodiment, the content enhancement platform 100 communicates with the content providers 24 to receive restaurant or movie reviews, which the content enhancement platform 100 uses as the additional information. As discussed above with reference to the advertiser 22, the content enhancement platform 100 can receive information from the information providers 20 and the content providers 24 in real-time.

It is noted that the content enhancement platform 100 is not limited to performing actions related to content enhancement between two communicating peer devices. For example, the content enhancement platform 100 may perform content enhancement between any suitable types of communicating terminals, including computer terminals, special purpose communications terminals such as those configured for use in a vehicle, mobile telephones, or PDAs.

### Content Enhancement Platform Components

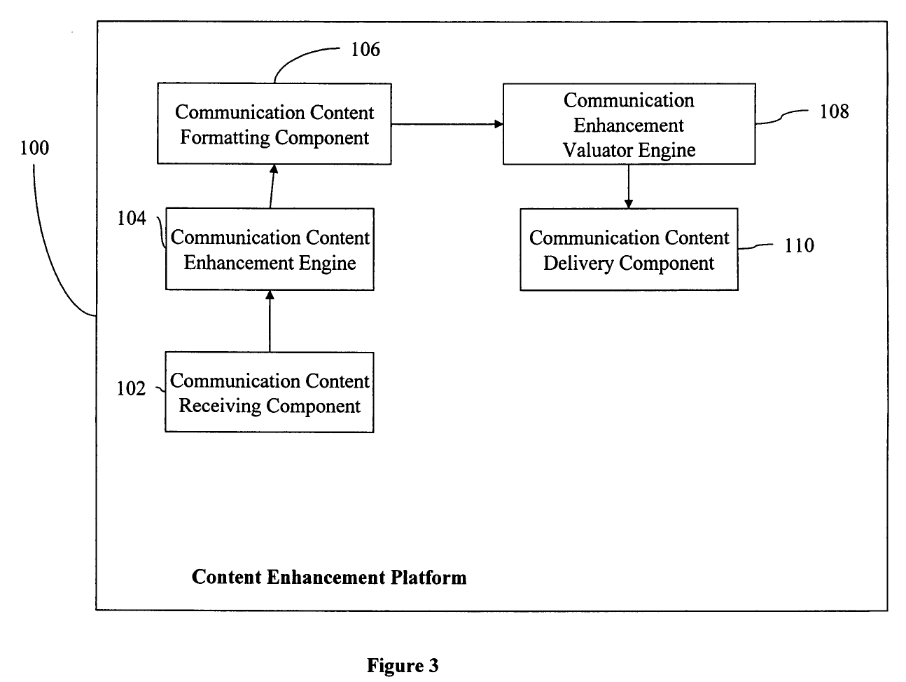

FIG. 3 depicts an exemplary embodiment of the architecture of the content enhancement platform 100 (see also FIG. 2). As shown in FIG. 3, the content enhancement platform 100 includes a communication content receiving component 102, a communication content enhancement engine 104, a communication content formatting component 106, a communication enhancement evaluator engine 108, and a communication content delivery component 110. It is noted that the illustrated components 102, 104, 106, 108, 110 may be implemented on a single computer processing unit, or on several computer processing units.

The communication content receiving component 102 and the communication content delivery component 110 are interfaces for transferring information to one or more networks. In the illustrated embodiment, the communication content receiving component 102 receives messages sent over the network 12 by the source peer S1, and, after the content of the received message is analyzed and modified, the communication content delivery component 110 routes the modified message to the destination peer R1 (see FIG. 2). The communication content receiving component 102 and the communication content delivery component 110 therefore together form a content communications gateway.

If the received message is from a source peer who is a subscriber of the content enhancement services, then the communication content receiving component 102 forwards the message to the communication content enhancement engine 104. The communication content enhancement engine 104 opens up the message, and analyzes the content of the message to determine the context of the message. In one embodiment, the context of the message is identified by analyzing the content of the message, the demographics of the destination peer (e.g., the age and gender of the destination peer), the locations of the respective peers, and the time that the message was sent.

For example, if a user of a source peer sends a message to a male user of a destination peer who is below the age of 22 to get something to eat at Times Square, then the communication content enhancement engine 104 selects additional information related to restaurants located at Times Square that is catered to the demographics of the user of the destination peer. If the user of the source peer sends a message to the user of the destination peer to get something to eat at 9:00 a.m., then the communication content enhancement engine 104 selects additional information pertaining to places that serve breakfast. However, if the user of the source peer sends a message to the user of the destination peer to get something to eat at 6:00 p.m., then the communication content enhancement engine 104 selects additional information pertaining to places that serve dinner.

After the communication content enhancement engine 104 identifies the context of the received message for use in selecting additional information for the message, the received message and the additional information are forwarded to the communication content formatting component 106, which inserts the additional information into the original message. In one embodiment, the method of modifying the original message to include the additional information is dependent upon the service being used. For example, if the video conferencing service is being used, then the communication content formatting component 106 may format the original message so that the additional information appears as a banner at the bottom of the video screen.

Once the communication content formatting component 106 modifies the message to include the selected additional information, the modified content is forwarded to the content enhancement evaluator engine 108, which ascertains the value of the content, and records the information relating to the content delivery, the value ascertained, and the source peer and destination peer information. For example, if a particular advertiser's advertisement is used as the additional information, then the communication enhancement evaluator engine 108 determines and records the charges for the advertiser. Thus, the communication enhancement evaluator engine 108 provides real-time evaluation of the use of advertisements.

In another embodiment, an operator of the content enhancement platform 100 uses the recorded information to identify incentives or subsidies that are optionally extended to the communicating peers. For example, the communication enhancement evaluator engine 108 may issue a credit for a predetermined amount to a source peer each time the source peer sends a message to a destination peer using the content enhancement services. In this way, the operator of the content enhancement platform 100 can provide an incentive for users of source peers to subscribe to the content enhancement services.

### Content Enhancement Platform Operation

When a user of a source peer subscribes to the content enhancement services, the user provides declarations corresponding to users of one or more destination peers. In one embodiment, a declaration of a destination peer (i.e., the recipient of a message sent by the source peer) includes the identity, age, and gender of the user of the destination peer. The age and gender of the user of the destination peer are collectively referred to herein as the demographics of the user of the destination peer.

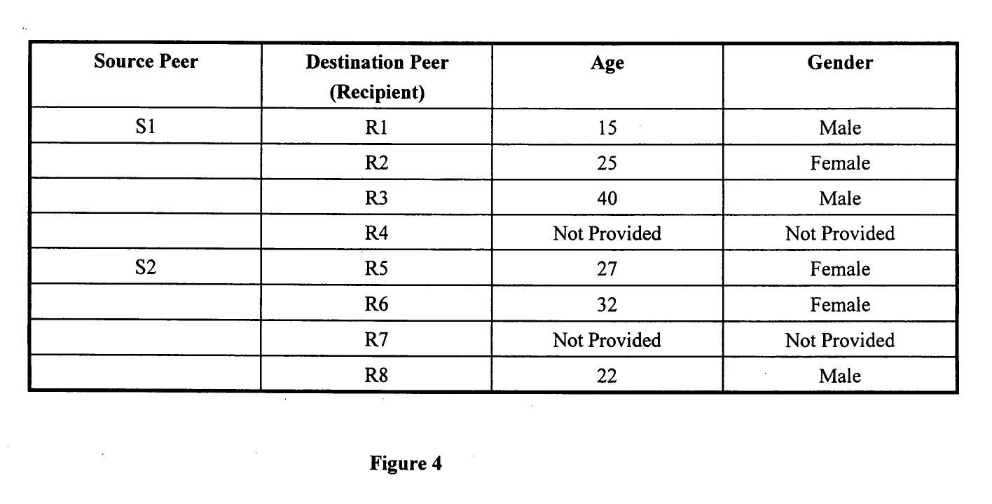

FIG. 4 illustrates an exemplary database containing declarations for a number of representative users of destination peers. In one embodiment, the content enhancement platform 100 stores the information illustrated in FIG. 4 in any suitable memory device included in the content enhancement platform 100. As shown in FIG. 4, users of source peers S1, S2 have subscribed to the content enhancement services. Further, the user of the source peer S1 has made declarations for users of destination peers R1, R2, R3, R4, and the user of the source peer S2 has made declarations for users of destination peers R5, R6, R7, R8. FIG. 4 also indicates the ages and gender of the respective users of the destination peers. For example, the user of the destination peer R1 is specified as a male of age 15.

In another embodiment, while the user of a source peer may provide the identity of a user of a destination peer, the source peer may not specify the age and gender of the destination peer user. For example, although the user of the source peer S1 has specified the ages and gender of the destination peers R1-R3, the age and gender of the destination peer R4 is unspecified. Once a destination peer is declared for a source peer, the content enhancement platform 100 selects additional information for messages sent from source peer to the declared destination peer using the demographics provided.

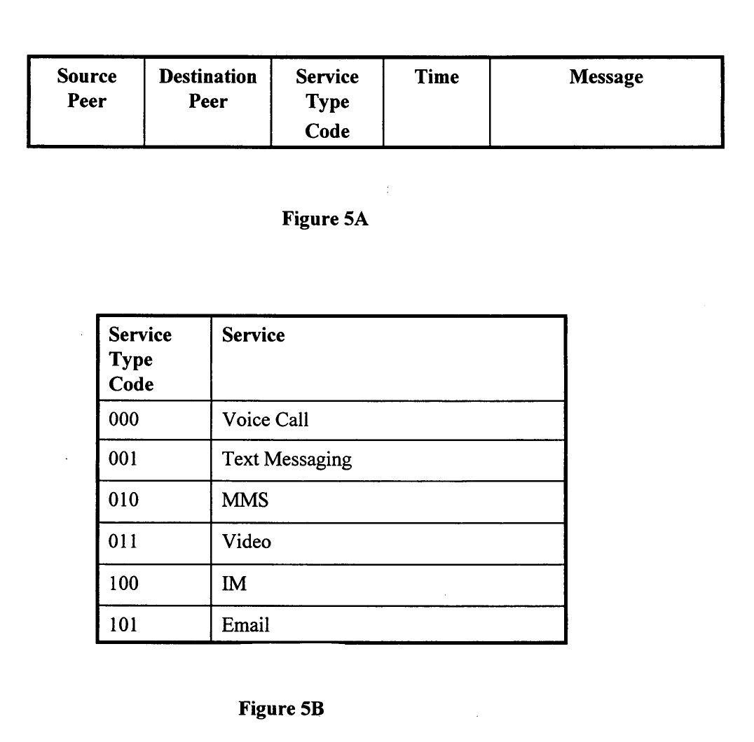

When a source peer sends a message to a destination peer, the content enhancement platform 100 receives the message in the form of a message packet. An exemplary format of a message packet is illustrated in FIG. 5A. As shown in FIG. 5A, a message packet includes the identities of the source and destination peers, a service type code indicating the service being used, the time the message is being sent, and the content of the original message. It is noted that the message packet may be formatted to conform to any suitable network protocol. For example, if the message packet of FIG. 5A is received over a network running the Internet protocol, then the message packet contains additional header information that is used for IP networks.

The format of the content of the message in the message packet is dependent upon the type of service being used. For example, if the source peer is sending a text message to a destination peer, then the message is in any suitable text format. However, if the source peer is making a voice call to the destination peer, then the message is in any suitable format that allows a device such as a cell phone to convert the message into an audible voice signal.

FIG. 5B illustrates sample service type codes and a corresponding service. When the content enhancement platform 100 receives a message packet like the one illustrated in FIG. 5A, the content enhancement platform 100 determines the type of service being requested from the service type code. For example, FIG. 5B illustrates the service type code “000” corresponding to a voice call. However, a service type code “001” corresponds to the text messaging service. As discussed above, the format of the message in the message packet is dependent upon the service being used. It is noted that the content enhancement platform 100 is not limited to the formats of the messages corresponding to the services illustrated in FIG. 5B; the content enhancement platform may be configured to modify any message corresponding to any suitable service.

When a user of a source peer who has subscribed for the content enhancement services sends a message to a user of a destination peer who is declared, the content enhancement platform 100 opens up the received message packet to extract the message, and analyzes the content of the message. In one embodiment, to extract a message contained in a received message packet, the content enhancement platform 100 removes the header information from the message packet to retrieve the message. For example, if the content enhancement platform 100 receives the message packet over an IP network, then the content enhancement platform 100 removes the header information used to transmit packets over IP networks to retrieve the message contained in the message packet.

Once the message is extracted from the message packet, the content enhancement platform 100 uses any suitable algorithm and software to analyze the content of a message. For example, if the user of the source peer is making a voice call to the user of the destination peer, then the content enhancement platform uses any suitable speech recognition software to analyze the content of the message. In another example, if the user of the source peer is sending a text message to the destination peer, then the content enhancement platform 100 uses any suitable algorithm implemented in any suitable software language to parse the text message.

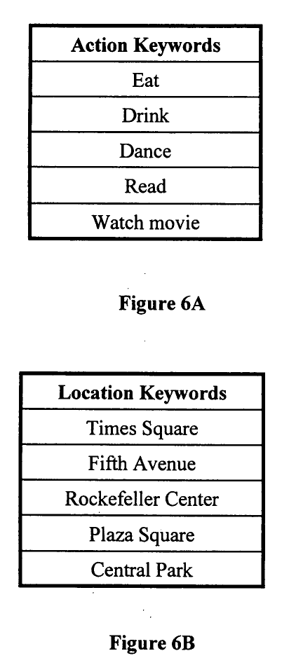

When analyzing the content of a message, the content enhancement platform 100 searches for keywords. According to one embodiment of the present invention, the keywords include certain actions or activities that the source peer and the destination peer wish to perform, and the locations where the desired actions are planned to take place. Exemplary action keywords are illustrated in FIG. 6A. For example, the content enhancement platform 100 is configured to recognize action keywords such as eat, drink, dance, read, and watch a movie. Exemplary location keywords are illustrated in FIG. 6B. For example, FIG. 6B illustrates that the content enhancement platform 100 is configured to recognize location keywords such as Time Square, Fifth Avenue, Rockefeller Center, Plaza Square, and Central Park.

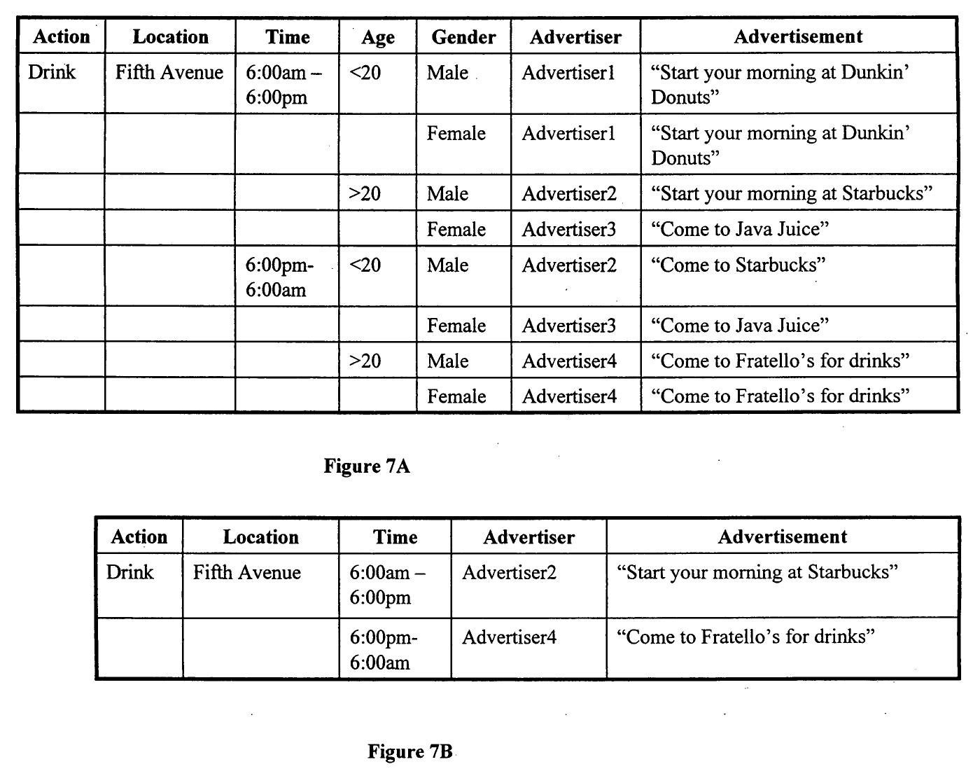

After the content enhancement platform 100 identifies keywords from the original message, the content enhancement platform 100 references the keywords in a database that contains the additional information. An exemplary embodiment of a specific advertisement database is illustrated in FIG. 7A. As defined herein, a specific advertisement database provides an advertisement based upon the destination peer user's demographic information such as age and gender. Additionally, the specific advertisement database illustrates the keywords that are referenced in the database, a specific time period, and the advertiser for each advertisement. For example, FIG. 7A illustrates that the advertisement of Advertiser1 is selected when the keywords “drink” and “Fifth Avenue” are identified for a male user of a destination peer under the age of 20 between the time period of 6:00 a.m. and 6:00 p.m.

As an example, when an advertiser's advertisement is selected, the content enhancement platform 100 uses the advertisement already contained in the database. In another embodiment, when an advertiser's advertisement is selected, the content enhancement platform 100 contacts the advertiser through any suitable communications method to receive an advertisement in real-time. For example, the content enhancement platform 100 of FIG. 2 uses the network 18 to contact the advertisers 22. After contacting the advertiser 22, the content enhancement platform 100 receives an advertisement in real-time from the respective advertiser.

An exemplary embodiment of a general advertisement database is illustrated in FIG. 7B. Compared to the specific advertisement database of FIG. 7A, the general advertisement table does not take into account the destination peer user's demographic information such as age and gender. For example, when the content enhancement platform 100 identifies the keywords “drink” and “Fifth Avenue” during the time period of 6:00 a.m. to 6:00 p.m., the content enhancement platform 100 selects an advertisement of Advertisers2. As discussed above, in one embodiment, the content enhancement platform 100 uses the advertisement already contained in the database for Advertiser2. In another embodiment, the content enhancement platform 100 communicates with the advertiser to obtain an advertisement in real-time.

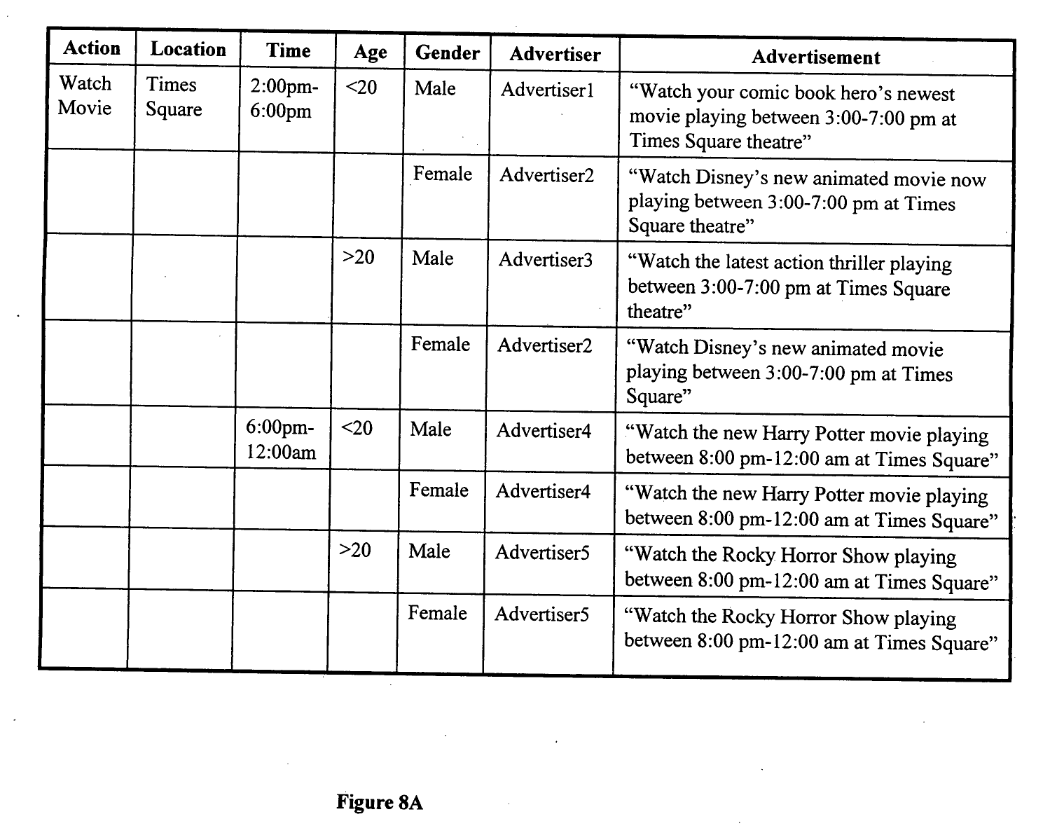

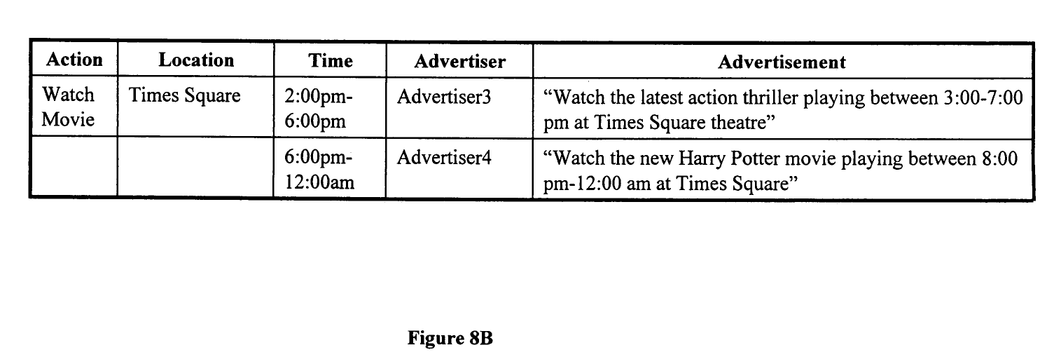

An exemplary embodiment of a specific advertisement database for the keywords “watch”, “movie”, and “Time Square” is illustrated in FIG. 8A. For example, when the content enhancement platform 100 identifies the keywords “watch”, “movie”, and “Times Square” for a female user of a destination peer below the age of 20 between the time periods of 6:00 p.m. and 12:00 a.m., the content enhancement platform 100 selects an advertisement of Advertiser4. In one embodiment, the content enhancement platform 100 selects the advertisement already contained in the database such as “Watch the new Harry Potter movie playing between 8 p.m.-12 a.m. at Times Square”. In an another embodiment, the content enhancement platform 100 contacts the advertiser using any suitable communications method to obtain an advertisement from the advertiser in real-time.

A general advertisement database for the keywords “watch”, “movie”, and “Times Square” is illustrated in FIG. 8B. For example, FIG. 8B illustrates that when the content enhancement platform 100 identifies the keywords “watch”, “movie”, and “Times Square” between the time period of 2 p.m. and 6 p.m., the content enhancement platform 100 selects the advertisement of Advertiser3.

It is noted that the content enhancement platform is not limited to using the keywords and additional information illustrated in FIGS. 7A-8B. The content enhancement platform can be configured to identify any desired keywords and to select any desired additional information based upon the identified key words. For example, in one embodiment, if the keywords “eat” and “Fifth Avenue” are identified in a received message, then the content enhancement platform 100 may select an advertisement for a restaurant. In another embodiment, the content enhancement platform 100 may select as additional information a directory containing a restaurant's address and phone number. In another embodiment, the content enhancement platform 100 may select as additional information a restaurant review.

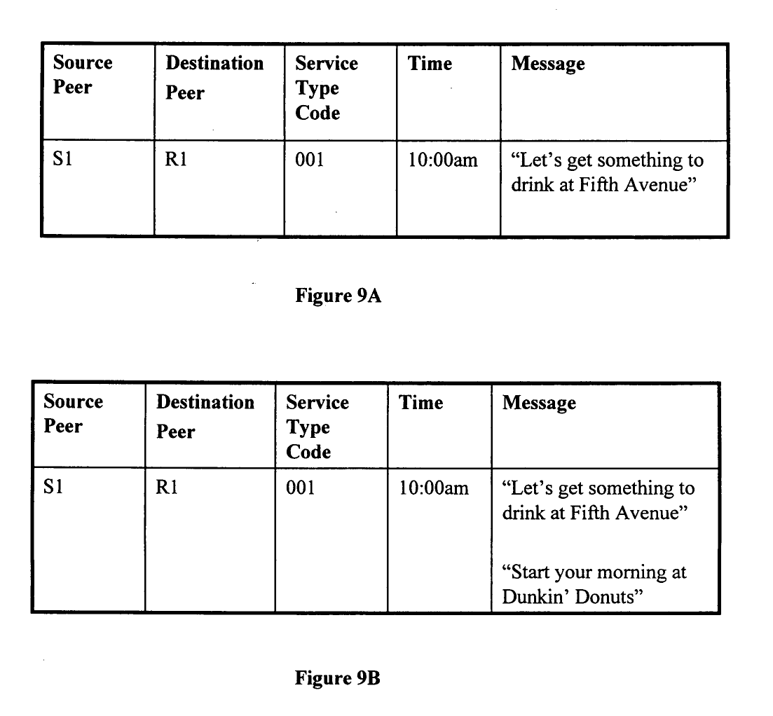

Examples of how the content enhancement platform 100 processes text messages are illustrated in FIGS. 9A-11. When a source peer sends a message to a destination peer, the content enhancement platform receives a message packet containing the original message. FIG. 9A illustrates an exemplary message packet that conforms to the format illustrated in of FIG. 5A.

Specifically, FIG. 9A illustrates that a source peer S1 is sending a message to a destination peer R1. Using the information illustrated in FIG. 4, the content enhancement platform 100 determines that the source peer S1 has subscribed for the content enhancement services, and has declared the destination peer R1. The message packet of FIG. 9A contains a service type code 001. Using the information illustrated in FIG. 5B, the content enhancement platform 100 determines that a service type code “001” corresponds to the text messaging service. Furthermore, the message packet depicted in FIG. 9A illustrates that the source peer S1 sent a text message to the destination peer R1 at 10:00 a.m.

After the content enhancement platform 100 determines that the source peer S1 is a subscriber to the content enhancement services and is sending a message to a declared destination peer R1, the content enhancement platform 100 extracts the message contained in the received message packet and analyzes the content of the message. For example, the message packet depicted in FIG. 9A contains a text message “Let's get something to drink at Fifth Avenue”. In one embodiment, the content enhancement platform 100 uses any suitable algorithm implemented in any suitable software to parse the text message to identify keywords. For example, after the text message of FIG. 9A is parsed and analyzed, the content enhancement platform 100 may use the information illustrated in FIG. 6A to identify the action keyword “drink”. Furthermore, using the information illustrated in FIG. 6B, the content enhancement platform 100 may identify the location keyword “Fifth Avenue”.

The content enhancement platform 100 uses the information illustrated in FIG. 4 to determine the specified demographics of the destination peer R1. For example, FIG. 4 indicates that the destination peer R1 is specified as a male of age 15. Since the demographics are specified for the destination peer R1, the content enhancement platform uses a specific advertisement database, such as the database illustrated in FIG. 7A, for the keywords “drink” and “Fifth Avenue”. The message packet of FIG. 9A illustrates that the source peer S1 is sending a text message to the destination peer R1 at 10:00 a.m. The specific advertisement database illustrated in FIG. 7A shows that the content enhancement platform 100 selects an advertisement of Advertiser1 when a male user of a destination peer below the age of 20 receives a message between the time period of 6:00 a.m. and 6:00 p.m.

As an example, after the content enhancement platform 100 selects the advertisement of Advertiser1, the content enhancement platform 100 uses the advertisement of Advertiser1 currently stored in the database. Therefore, as illustrated in the modified message packet of FIG. 9B, the message is modified to recite the original message and the advertisement “Start your morning at Dunkin' Donuts™”. In another embodiment, the content enhancement platform 100 contacts the advertiser to receive an advertisement in real-time. After the content enhancement platform 100 receives the advertisement from the advertiser, the content enhancement platform 100 modifies the message in the message packet to include the received advertisement.

After the content enhancement platform 100 modifies the message in the message packet, the content enhancement platform 100 encodes the message packet to correspond to the network protocol of the network that the destination peer is using. As an example, if the message packet is forwarded to a destination peer that is using an IP network, then the content enhancement platform 100 encodes the message packet to correspond to the IP protocol before forwarding the packet to the destination peer.

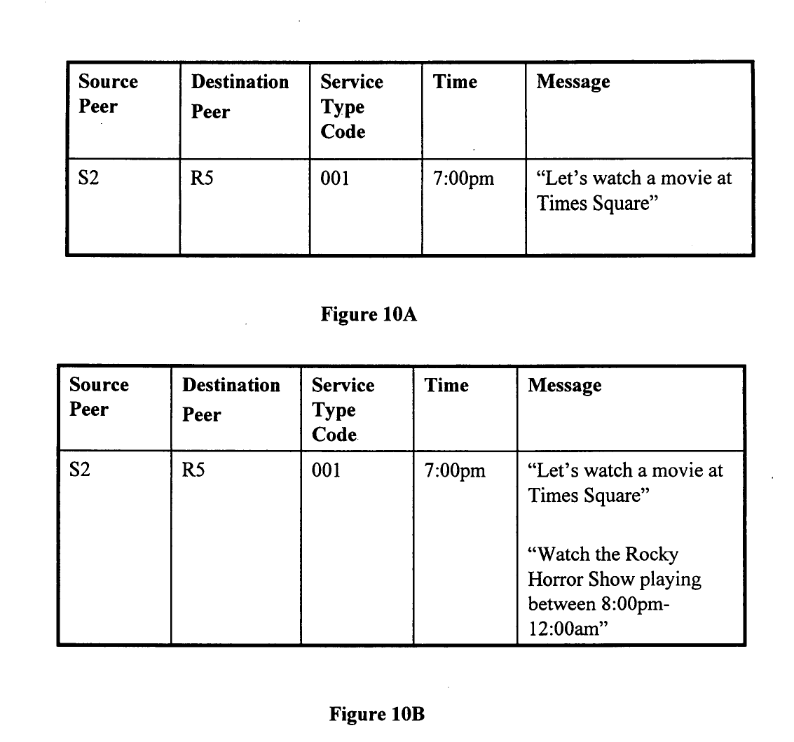

Another example message packet is illustrated in FIG. 10A, which indicates that a source peer S2 is sending a message to a destination peer R5. Using the information illustrated in FIG. 4, the content enhancement platform 100 determines that the source peer S2 has subscribed to the content enhancement service, and has declared the destination peer R5. Using the information illustrated in FIG. 5B, the content enhancement platform 100 determines that the source peer S2 is sending a text message. Furthermore, FIG. 10A indicates that the source peer S2 is sending a text message to the destination peer R5 at 7:00 p.m.

After the content enhancement platform 100 determines that a source peer who has subscribed to the content enhancement service is sending a message to a declared destination peer, the content enhancement platform 100 analyzes the message in the message packet. As described above, the content enhancement platform 100 analyzes the message to identify keywords. For example, FIG. 10A illustrates the message “Let's watch a movie at Times Square”. Using the action key words illustrated in FIG. 6A, the content enhancement platform 100 identifies the keywords “watch” and “movie”. Furthermore, using the location keywords illustrated in FIG. 6B, the content enhancement platform 100 identifies the keywords “Times Square”.

The content enhancement platform 100 uses the information illustrated in FIG. 4 to determine that the user of the destination peer R5 is a female of age 27. Since the demographics for the destination peer R5 are specified, the content enhancement platform 100 uses a specific advertisement database for the keywords “watch”, “movie”, and “Times Square”. In one embodiment, the content enhancement platform 100 uses the specific advertisement table illustrated in FIG. 8A for the keywords “watch”, “movie”, and “Times Square”. The message packet illustrated in FIG. 10A indicates that the source peer S2 is sending a text message at 7:00 p.m. FIG. 8A illustrates that the advertiser, Advertiser5, is selected when a female user of a destination peer above the age of 20 receives a text message between the time period of 6:00 p.m. and 12:00 a.m.

In one embodiment, after the content enhancement platform 100 selects an advertiser, the content enhancement platform 100 uses the advertisement currently contained in the database. FIG. 8A illustrates that the currently listed advertisement of Advertiser5 is “Watch the Rocky Horror Show playing between 8:00 p.m.-12:00 a.m. at Times Square”. Therefore, the content enhancement platform 100 modifies the original message to include the advertisement illustrated in FIG. 10B. In another embodiment, the content enhancement platform 100 contacts the advertiser to receive an advertisement in real-time. After the advertisement is received, the content enhancement platform 100 modifies the message in the message packet to include the received advertisement. FIG. 10B illustrates that after the message is modified, the destination peer R5 receives the original message, “Let's watch a movie at Times Square”, and the advertisement “Watch the Rocky Horror Show playing between 8:00 p.m.-12:00 a.m.”

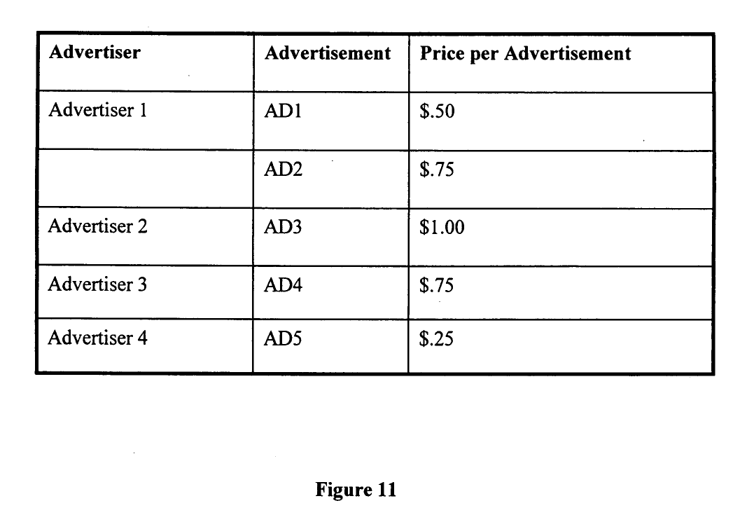

According to one embodiment of the present invention, when the content enhancement platform 100 selects the advertisement of an advertiser, the advertiser is charged each time the advertisement is used. The operator of the content enhancement platform 100 contracts with the advertisers for different rates for each advertisement. An exemplary embodiment of an advertisement rate plan is illustrated in FIG. 11, which shows a plurality of advertisers (Advertiser1-Advertiser4), at least one advertisement (AD1-AD2) for each respective advertiser, and the price per advertisement. For example, FIG. 11 illustrates that Advertiser1 offers two advertisements AD1 and AD2. Each time advertisement AD1 is used, Advertiser1 is charged 50 cents. Each time advertisement AD2 is used, Advertiser 1 is charged 75 cents.

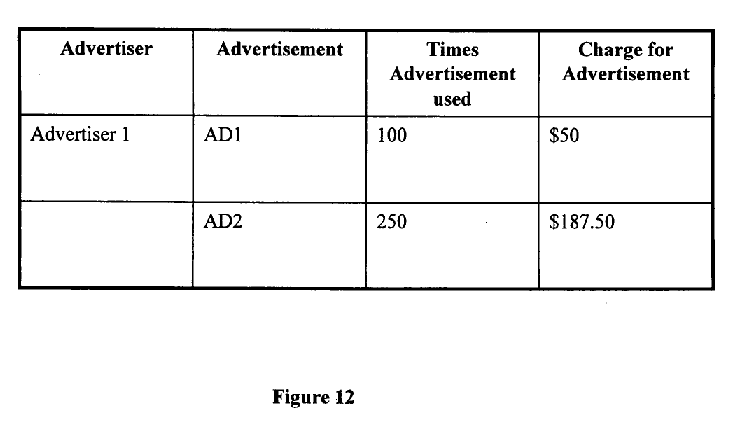

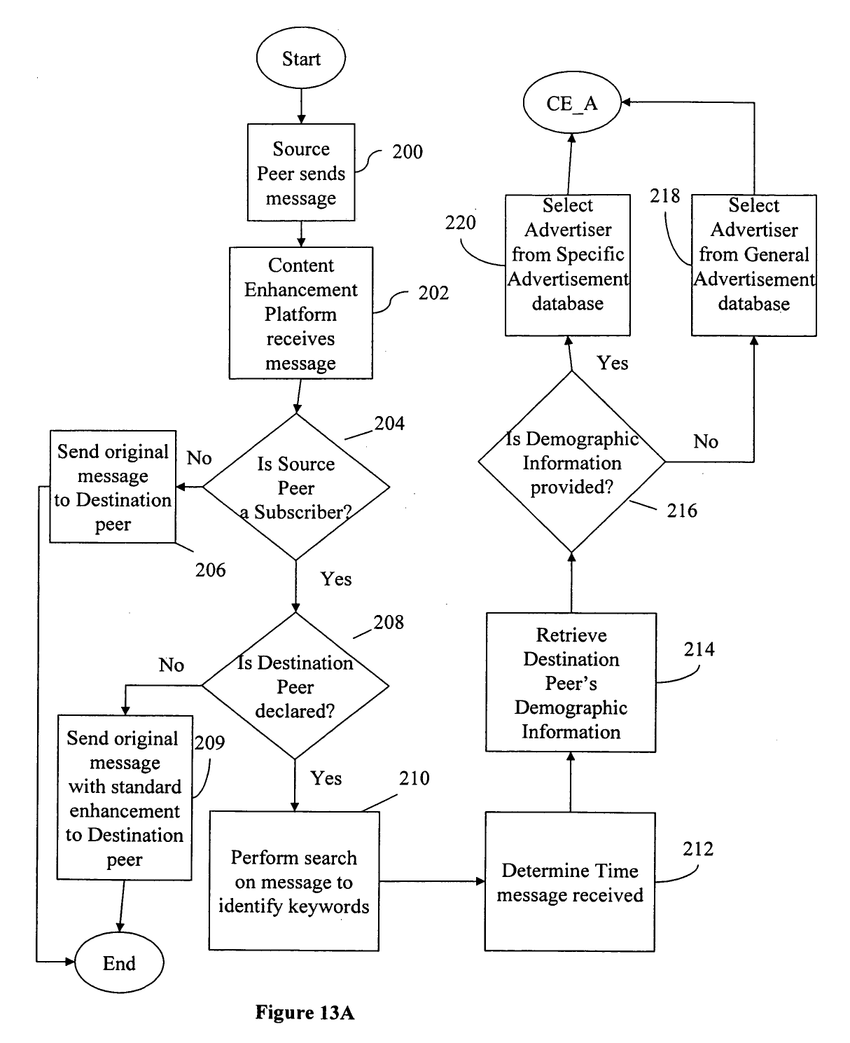

The content enhancement platform 100 keeps track of an account for each advertiser. An exemplary format of an advertiser account is illustrated in FIG. 12. The advertiser account of FIG. 12 shows the advertiser, each advertisement offered by the advertiser, the times the advertisement is used, and the charge for the advertisement. For example, FIG. 12 illustrates an advertiser account for Advertiser1. Advertiser 1 offers advertisements AD1 and AD2. The advertiser account of FIG. 12 further illustrates that advertisement AD1 was used 100 times, while advertisement AD2 was used 250 times. Using the advertisement rate plan illustrated in FIG. 11, the content enhancement platform determines the charge for each advertisement. For example, FIG. 11 illustrates that Advertiser1 is charged 50 cents each time advertisement AD1 is used. Therefore, since advertisement AD1 was used 100 times, Advertiser 1 is charged 50 dollars for advertisement AD1.

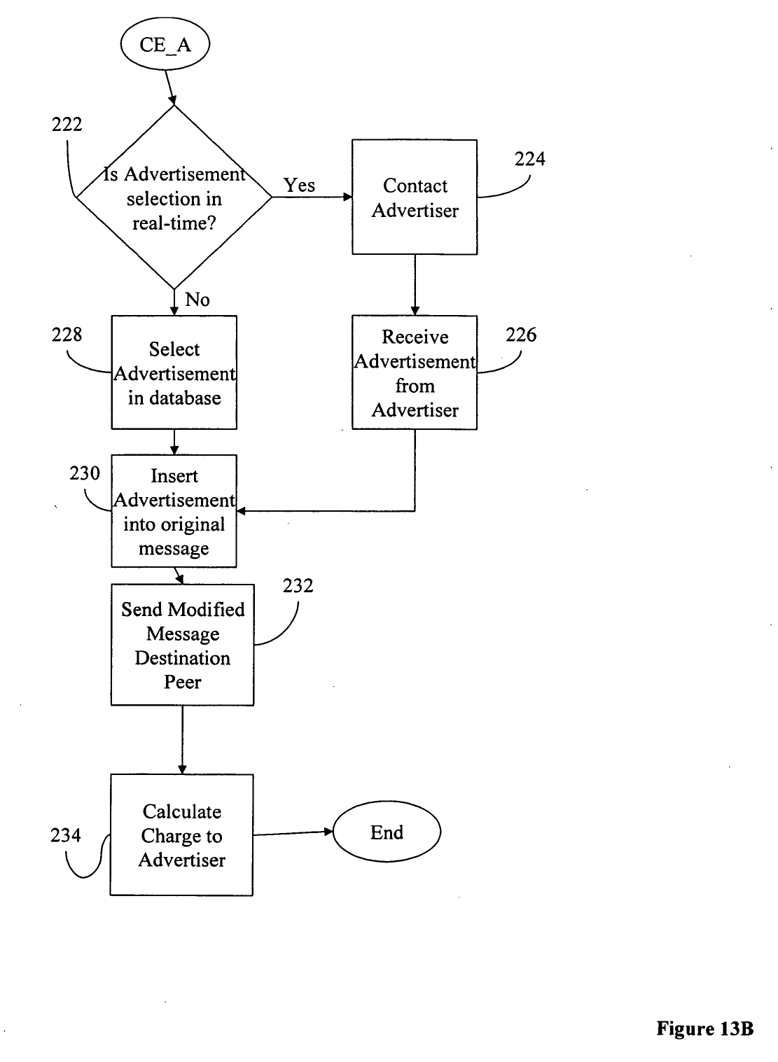

An exemplary method for content enhancement is illustrated in the flow diagrams of FIGS. 13A and 13B. The content enhancement process starts when step 200 sends a message. As an example, the content enhancement process is started when the source peer sends a message to a destination peer. Step 202 receives the message. For example, as illustrated in FIG. 2, when the source peer S1 sends a message to the destination peer R1, the message is routed from the network access point 10 through the network 12 to the content enhancement platform 100. When the content enhancement platform receives the message, in one embodiment, the message is received as a message packet, as illustrated in FIG. 5A.

Step 204 determines if the user of the source peer is a subscriber of the content enhancement services. As an example, the content enhancement platform receives a message packet, as illustrated in FIG. 9A, indicating that the source peer S1 is sending a message. Using the information illustrated in FIG. 4, the content enhancement platform finds that the source peer S1 is listed in the first column. Therefore, the content enhancement platform determines that the source peer S1 is a subscriber of the content enhancement services. If the user of the source peer is not a subscriber of the content enhancement services, then flow proceeds from step 204 to step 206 where the original message is sent to the destination peer. For example, as illustrated in FIG. 2, if the source peer is not a subscriber, then the content enhancement platform 100 routes the message to the destination peer R1 without extracting the message contained in a received message packet and analyzing the extracted message. After step 206 sends the original message to the destination peer, the content enhancement process ends.

If the source peer is a subscriber of the content enhancement services, then flow proceeds form step 204 to step 208. Step 208 determines if the destination peer is declared. As an example, the received message packet as illustrated in FIG. 9A shows that the destination peer is R1. The content enhancement platform determines from column 2 of FIG. 4 that the destination peer R1 is a declared destination peer for the source peer S1. If the destination peer R1 were not a declared destination peer for the source peer S1, then the destination peer R1 would not appear in the declarations for the source peer S1.

If the destination peer is not declared, flow proceeds from step 208 to step 209 where the original message with a standard enhancement is sent to the destination peer. In one embodiment, a standard enhancement is a message independent of the content of the original message. For example, when the destination peer is not declared, the content enhancement platform inserts a message such as “Become a declared recipient for content enhancement services today and receive free credit towards your account!” or “Buy one get second one free” at a specified store or restaurant, for example. In another embodiment, a standard enhancement is dependent upon the content of the message where the content enhancement platform analyzes the content of the message. For example, if the content enhancement platform identifies the keyword “drink”, the content enhancement platform inserts a message such as “Be safe, don't drink and drive”. The process of analyzing the content of a message and identifying keywords is described below for step 210.

If the destination peer is declared, then flow proceeds from step 208 to step 210. Step 210 performs the search on the received original message to identify keywords. The type of search performed is dependent upon the type of service used for transmitting the message. FIG. 5A illustrates that the message packet has a service type code field. Using the information illustrated in FIG. 5B, the content enhancement platform determines the service being used to transmit the message. For example, if the received message packet has a service type code “000”, then the source peer is making a voice call to the destination peer. However, if the service type code of the received message packet is “001”, then the source peer is transmitting a text message to the destination peer.

In one embodiment, if the source peer is making a voice call to the destination peer, the content enhancement platform uses any suitable speech recognition algorithm implemented in any suitable software to search the message for keywords. In another embodiment, if the source peer is sending a text message to the destination peer, the content enhancement platform uses any suitable text searching algorithm implemented in any suitable software to search the received message for identifying keywords.

As an example, the content enhancement platform uses the information illustrated in FIGS. 6A and 6B, respectively, to identify keywords. For example, FIG. 6A illustrates exemplary action keywords, while FIG. 6B illustrates exemplary location keywords. The received message packet illustrated in FIG. 9A shows that the received message is “Let's get something to drink at Fifth Avenue”. Therefore, after performing the search of the message, the content enhancement platform identifies the keyword “drink” from the action key words listed in FIG. 6A and the keywords “Fifth Avenue” from the location keywords listed in FIG. 6B.

After the key words are identified from the received message, flow proceeds from step 210 to step 212. Step 212 determines the time the message is received. As an example, the content enhancement platform determines the time the message is received from the message packet format as illustrated in FIG. 5A.

In an alternative embodiment, step 212 determines the time an event is planned to take place. For example, if the received message stated “Let's get something to eat in an hour”, and the time indicated in the received message packet is 10:00 a.m., then the content enhancement platform is configured to determine that the event is planned for 11:00 a.m.

Step 214 retrieves the destination peer user's demographic information. As an example, step 214 uses the information illustrated in FIG. 4 to find a destination peer user's demographic information. Step 216 determines if the demographic information is provided. For example, FIG. 4 illustrates the demographic information for destination peer R1 is provided, where user of the destination peer R1 is specified as a male of age 15. However, FIG. 4 further illustrates that the demographic information for the user of the destination peer R4 is not provided. If the demographic information is not provided, then flow proceeds from step 216 to step 218. Step 218 selects an advertiser from the general advertisement database. As an example, if the content enhancement platform identified the keywords “drink” and “Fifth Avenue”, the content enhancement platform uses the information illustrated in FIG. 7B to select an advertiser. If the message is received at the content enhancement platform between the time period of 6:00 a.m. to 6:00 p.m., then the content enhancement platform selects Advertiser2.

If the demographic information for the destination peer is provided, then flow proceeds from step 216 to step 220. Step 220 selects an advertiser from a specific advertisement database. As an example, if the content enhancement platform identifies the keywords “drink” and “Fifth Avenue” in the received message, then the content enhancement platform uses the information illustrated in FIG. 7A to select an advertiser. If the user of the destination peer is a male under the age of 20, and the content enhancement platform receives the message between the time period of 6:00 a.m. to 6:00 p.m., then the content enhancement platform selects Advertiser1. Flow proceeds from step 218 to process CE_A of FIG. 13B after an advertiser is selected from the general advertisement database. Furthermore, flow proceeds from step 220 to process CE_A after an advertiser is selected from the specific advertisement database. In alternative embodiments, steps 218 and 220 select general information providers from a general and specific database, respectively, instead of advertisers.

Process CE_A of FIG. 13B starts at step 222. Step 222 determines if the advertisement selection is in real-time. According to one embodiment of the present invention, the advertisers contract with the operator of the content enhancement platform to provide the content enhancement platform with advertisements in real-time. If the advertisement selection is in real-time, then flow proceeds from step 222 to step 224. Step 224 contacts the advertiser, and step 226 receives the advertisement from the advertiser. As an example, a content enhancement platform uses any suitable communications method to contact the advertiser to receive an advertisement.

If the advertisement selection is not in real-time, then flow proceeds from step 222 to step 228. Step 228 selects the advertisement already contained in the database used for selecting an advertiser. For example, if the content enhancement platform selected Advertiser2 from the general advertisement database illustrated in FIG. 7B, then the content enhancement platform selects the advertisement “Start your morning at Starbucks™”.

After an advertisement is received in step 226 or selected in step 228, flow proceeds to step 230. Step 230 inserts the advertisement into the original message. According to one embodiment of the present invention, modifying the original message to include the advertisement depends upon the service being used. For example, if the source peer is making a voice call to the destination peer, modifying the original message to include the advertisement includes inserting a prerecorded message into the original message. If the source peer is sending a text message to the destination peer, modifying the original message to include the advertisement includes appending an additional text message to the end of the original received message.

After the original message is modified, step 232 sends the modified message to the destination peer. Step 234 calculates the charge to the advertiser. As an example, if the content enhancement platform used advertisement AD1 of Advertiser1, then the content enhancement platform uses the information illustrated in FIG. 11 to determine that Advertiser1 is charged 50 cents each time advertisement AD1 is used. The content enhancement platform locates Advertiser1's account and updates the account to reflect the use of advertisement AD1, as illustrated in FIG. 12. In one embodiment, the content enhancement platform locates Advertiser1's account in any suitable memory device included in the content enhancement platform. After the charge to the advertiser is calculated, the content enhancement process ends.

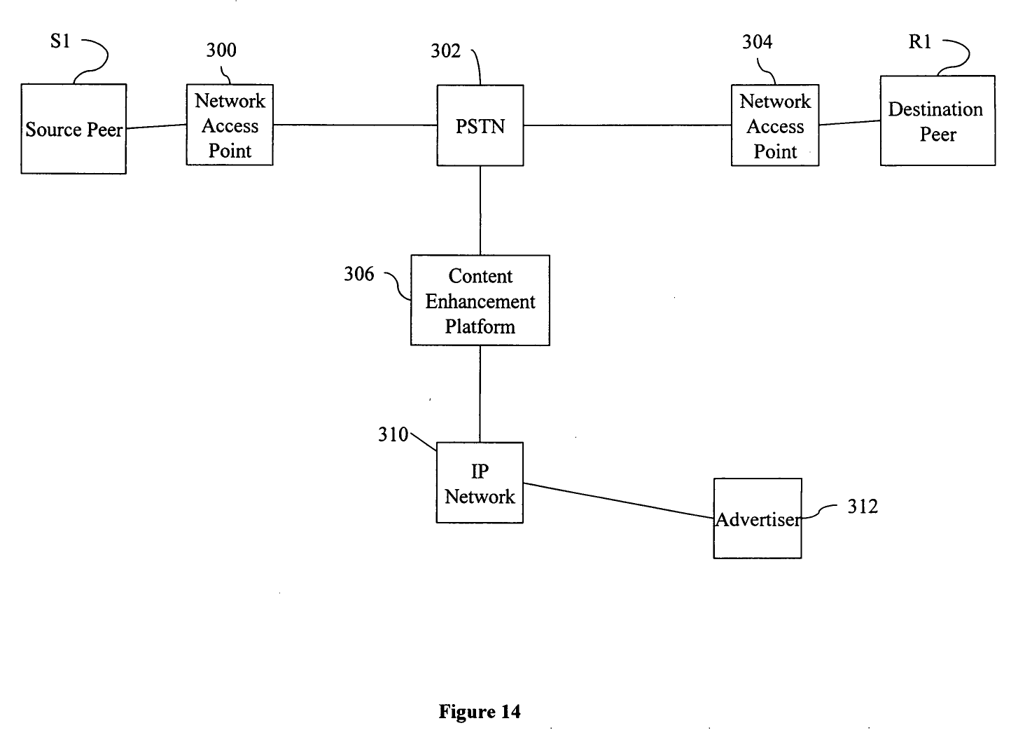

An example of a source peer sending a message to a destination peer is illustrated in FIG. 14. The source peer S1 sends a text message to the destination peer R1. In one embodiment, the text message is in a message package format as illustrated in FIG. 5A. The text message is routed from a network access point 300 through a public switch telephone network (PSTN) 302 to a content enhancement platform 306. In one embodiment, the content enhancement platform 306 performs substantially the same functions as described for the content enhancement platform 100 of FIG. 3. The network access point 300 serves substantially the same functions as described for the network access point 10 of FIG. 2. The PSTN 302 uses any suitable protocol such as signaling system 7 (SS7).

According to one embodiment of the present invention, the communication content receiving component receives the message from the source peer in a message packet encoded in the mobile application part (MAP) protocol, which resides on top of the SS7 protocol stack. The MAP protocol is configured to provide procedures for location management, subscriber data management, authentication, and text messaging services. Thus, the MAP protocol plays the role of transferring a mobile source peer's information from one network to another network. Additionally, the content enhancement platform 306 is integrated with the PSTN 302 as a first delivery attempt (FDA) server, which is referred to herein as a short message service center (SMSC).

According to one embodiment of the present invention, when the content enhancement platform 306 receives the message from the source peer, the content enhancement platform 306 performs the content enhancement method illustrated in FIGS. 13A and 13B. As an example, the source peer S1 sends a text message “Meet me at Starbucks at Times Square in an hour” to the destination peer R1. When the content enhancement platform 306 receives a message packet containing the text message, the platform extracts the text message and provides the message, and the source peer and the destination peer identifies, to the communication content enhancement engine of the content enhancement platform. The communication content enhancement engine analyzes the content of the message to ascertain the context of the communication and selects additional information to enhance the content. In one embodiment, the content enhancement engine uses the keyword databases as illustrated in FIG. 6A and FIG. 6B to identify keywords. Once the keywords are identified, the content enhancement engine uses a specific advertisement database or general advertisement database, as illustrated in FIGS. 7A-8B to select an advertiser. If the advertisement is not real-time, the content communication engine selects an advertisement already contained in an advertisement database. However, if the advertisement is in real-time, the content enhancement platform 306 uses the IP network 310 to receive an advertisement from the advertiser 312.

Once the communication content enhancement engine selects an advertisement or receives an advertisement from an advertiser, the communication content formatting component with the content enhancement platform merges the selected advertisement with the original message to create a modified message. For example, if the advertisement “Call 555-7900 for a QuickTaxi™ cab ride” is selected, then the modified message is “Meet me at Starbucks at Time Square in an hour. Call 555-7900 for a QuickTaxi™ cab ride.”

After the communication content formatting component of the content enhancement platform 306 modifies the message, the modified message is forwarded to the content evaluator engine to identify credits for the source peer and calculate a charge for the advertiser. For example, the content evaluator engine of the content enhancement platform uses the advertiser rate plans as illustrated in FIG. 11 to determine a price for an advertisement, and updates an advertiser's account as illustrated in FIG. 12. According to one embodiment of the present invention, the content enhancement platform provides a credit to the source peer S1 for using the content enhancement service. Thus, the source peer S1 may be provided a credit of, for example, one dollar.

After the content evaluator engine finishes evaluating the modified message, the communication content delivery component of the content enhancement platform encodes the modified message back into the MAP protocol and routes the message to the destination peer R1 through the PSTN 302 in the network access point 304.

The content enhancement platform is not limited to forwarding a message to a destination peer using the same service used by the source peer. For example, if the content enhancement platform receives a voice message from the source peer, then the content enhancement platform uses the method illustrated in FIGS. 13A-13B to enhance the message, and forwards the enhanced message as a text message to the destination peer. This situation arises when the source peer and the destination peer do not use the same service to communicate with each other. Further, if one person leaves a voice mail for another person, voice recognition processing can be used to determine if certain keywords or concepts are used in the voicemail. If a predetermined keyword or concept is employed, another voicemail with enhanced content can be sent or information appended to the end of the existing voicemail. Alternatively, an e-mail or test message with content enhancing information (e.g., advertising and/or marketing material) can be sent to the source and/or destination.

According to one embodiment of the present invention, when a source peer who subscribes to the content enhancement services declares a destination peer, the source peer further provides the service that the destination peer uses. For example, the declarations of destination peers illustrated in FIG. 4 can be modified to include the service the destination peer is using, such as text messaging. Therefore, before forwarding the enhanced message to the destination peer, the content enhancement platform refers to the information illustrated in FIG. 4 to format the enhanced message to correspond to the service the destination peer is using.

The various determinations, calculations, and steps performed by the present invention may be implemented using a suitably programmed general purpose digital computer, as will be apparent to those skilled in the art. Suitable software coding can be prepared by skilled programmers based upon the teachings of the present disclosure, as will be apparent to those skilled in the art. The present invention may also be implemented by the preparation of application specific integrated circuits (ASICS) or by interconnecting an appropriate network of conventional component circuits, as will be readily apparent to those skilled in the art.

The present invention includes a computer program product, which is a storage medium including instructions that can be used to program a computer to perform processes of the invention. The storage medium can include, but is not limited to, any suitable type of disk including floppy disks, optical disks, CD-ROMs, CDs, DVDS, and magneto-optical disks, ROMS, RAMs, EPROMs, EEPROMs, flash memory, magnetic or optical cards, or any suitable type of media for storing electronic instructions. The present invention further includes a computer program product which is a storage medium including encoded data output by the present invention stored on any of the above described media for storing electronic instructions or data.

It will be appreciated by those of ordinary skill in the art that modifications to and variations of the above-described method and apparatus for network based content enhancement may be made without departing from the inventive concepts disclosed herein. Accordingly, the invention should not be viewed as limited except as by the scope and spirit of the appended claims.

What is claimed is:

1. A method of enhancing content of at least one message sent by a source device to at least one destination device over at least one network, said method comprising the steps of:
receiving at least one message over at least one network, the received message being sent over the network by a source device, the received message having content associated therewith;
analyzing said content of the received message;
responsive to said analyzing of said content of the received message, selecting information based upon said content of the received message; and
transmitting, over the network, the message and the selected information to at least one destination device.

2. The method of claim 1 further including inserting the selected information into the message before transmitting the message and the selected information to the destination device.

3. The method of claim 1 wherein the received message comprises at least one message packet, and wherein said analyzing of said content includes extracting the message from the message packet.

4. The method of claim 1 wherein the destination device has a user associated therewith, wherein said method further includes accessing demographic information associated with the user of the destination device, and, wherein said selecting of information includes selecting information based upon said content of the received message and the demographic information associated with the user of the destination device.

5. The method of claim 1 wherein said analyzing of said content includes analyzing said content of the received message to determine a context of the message.

6. The method of claim 5 wherein said analyzing of said content to determine said context of, the message includes identifying one or more keywords included in said content of the received message.

7. The method of claim 6 wherein the received message corresponds to a voice call message, and wherein said identifying of one or more keywords includes using a speech recognition technique to identify said one or more keywords in said voice call message.

8. The method of claim 6 wherein the received message corresponds to a text message, and wherein said identifying of one or more keywords includes using a text searching technique to identify said one or more keywords in said text message.

9. The method of claim 6 wherein the identified keywords are indicative of one or more of at least one predetermined action and at least one predetermined location.

10. The method of claim 5 wherein the received message comprises at least one message packet, and wherein said analyzing of said content to determine said context of the message includes analyzing said content of the message packet to determine a time of receipt of the message.

11. The method of claim 5 wherein said analyzing of said content to determine said context of the message includes analyzing said content of the message to identify a specified event.

12. The method of claim 11 wherein said analyzing of said content to determine said context of the message includes determining a time associated with said specified event.

13. The method of claim 1 wherein said selecting of said information includes accessing said information from at least one database.

14. The method of claim 1 wherein said selecting of said information includes accessing said information over at least one network in real-time.

15. The method of claim 1 wherein the received message corresponds to a voice call message, and wherein said method further includes inserting the selected information into the message as a prerecorded message.

16. The method of claim 1 wherein the received message corresponds to a text message, and wherein said method further includes appending the selected information to the message as an additional text message.

17. The method of claim 1 wherein the selected information corresponds to at least one advertisement provided by at least one advertiser, and wherein said method further includes calculating a charge to said at least one advertiser for use of said at least one advertisement.

18. The method of claim 17 wherein the advertiser has an account associated therewith, and wherein said method further includes updating said account of the advertiser based upon the calculated charge to reflect said use of the advertisement.

19. The method of claim 17 wherein the source device has a user associated therewith, wherein the user of said source device has an account associated therewith, and wherein said method further includes updating said account of the user of the source device based upon a predetermined credit to reflect said use of the advertisement.

20. The method of claim 1 wherein said receiving of said at least one message includes receiving said at least one message over a public switch telephone network.

21. The method of claim 20 wherein said receiving, said analyzing, said selecting, and said transmitting are performed by a server integrated within said public switch telephone network.

22. The method of claim 21 wherein said server is associated with a short message service center.

23. The method of claim 1 wherein the received message has a first predetermined message format, and wherein the transmitted message has a second predetermined format, said first predetermined format being different from said second predetermined format.

24. A system for enhancing content of at least one message sent by a source device to at least one destination device over at least one network, said system comprising:
a message receiving component operative to receive at least one message over at least one network, the received message being sent over the network by a source device, the received message having content associated therewith;
a content analyzing component operative to analyze said content of the received message;
an information selecting component operative, responsive to analyzing said content of the received message, to select information based upon said content of the received message; and
a message transmitting component operative to transmit, over the network, the message and the selected information to at least one destination device.

25. The system of claim 24 further including a message formatting component operative to insert the selected information into the message before transmission of the message and the selected information to the destination device.
